(19) United States
(12) Patent Application Publication
(10) Pub. No.: US 2026/0191155 A1
(43) Pub. Date: Jul. 9, 2026

(54) Series-Parallel Circulating Irrigation Device for Ecological Restoration Slopes at Different Elevations in Pumped-Storage Power Station and Operation Method thereof

(71) Applicant: China Three Gorges University, Yichang (CN)

(72) Inventors: Daxiang Liu, Yichang (CN); Xingfeng Zhang, Yichang (CN); Lei Yang, Yichang (CN); Yueshu Yang, Yichang (CN); Yun Hu, Yichang (CN); Bingqin Zhao, Yichang (CN); Yuliang Qin, Yichang (CN); Xudong Hu, Yichang (CN); Liming Liu, Yichang (CN); Hai Xiao, Yichang (CN); Lun Zhang, Yichang (CN); Zhenyao Xia, Yichang (CN); Mingtao Zhou, Yichang (CN); Wennian Xu, Yichang (CN)

(21) Appl. No.: 19/437,147

(22) Filed: Dec. 30, 2025

(30) Foreign Application Priority Data
Jan. 3, 2025 (CN) 202510010427.8

(51) Int. Cl. A01G 25/02; A01G 25/16; F03B 13/06

(52) U.S. Cl. CPC A01G 25/02; A01G 25/167; F03B 13/06

(57) ABSTRACT

A series-parallel circulating irrigation device for ecological restoration slopes at different elevations in pumped-storage power station and operation method thereof, comprising a pipeline network system for irrigation water delivery; partial devices of the pumped-storage power station are connected to the pipeline network system to provide an irrigation water source; the pipeline network system is laid on the ecological restoration slopes; the pipeline network system is connected to a data acquisition and processing system, and an interior of the pipeline network system is provided with a filtration device. This device can fully utilize pumped-storage water resources, achieve targeted automatic irrigation for ecological restoration slopes at different elevations, and can also filter excess water resources for use in lower slope irrigation and power generation. This device organically integrates with the pumped-storage system, achieving water resource recycling and energy conservation.

### TECHNICAL FIELD

The invention belongs to the field of irrigation devices, specifically relating to series-parallel circulating irrigation device for ecological restoration slopes at different elevations in pumped-storage power station and operation method thereof.

### BACKGROUND ART

Pumped-storage power stations, as efficient energy storage and conversion facilities, are increasingly widely used globally. They balance power grid supply and demand fluctuations by using surplus electricity during low demand periods to pump water from a lower to a higher elevation, and then releasing water to generate electricity during peak demand periods. pumped-storage power stations play an important role in peak shaving and frequency regulation of power systems due to their flexibility, high efficiency, and large-scale energy storage characteristics.

However, the construction and operation of pumped-storage power stations inevitably have a series of impacts on the surrounding environment. During the power station construction process, large-scale earthwork and rock excavation are unavoidable, leading to extensive destruction of original vegetation, exposed slopes, and aggravated soil erosion. If ecological restoration is not conducted promptly, these exposed slopes will become the main source of soil and water loss, severely affecting the surrounding ecological environment. The lack of vegetation prevents rainwater from being effectively absorbed and retained, leading to increased surface runoff and affecting downstream water quality.

In recent years, relevant government departments have increasingly focused on ecological revegetation of slopes. However, the significant elevation difference between the upper and lower reservoirs of pumped-storage power stations, and the slopes often generated by power station engineering construction with notable elevation variations, make the allocation and transportation of irrigation water potentially difficult due to terrain and geological condition constraints. This increases irrigation difficulty, posing great challenges to vegetation growth and restoration. Furthermore, these slopes require substantial human resources for maintenance. In practice, insufficient human resources result in inadequate maintenance of some slopes, leading to poor ecological revegetation effects.

### SUMMARY OF THE INVENTION

The purpose of the invention is to provide series-parallel circulating irrigation device for ecological restoration slopes at different elevations in pumped-storage power station and operation method thereof. This device can fully utilize pumped-storage water resources to achieve targeted automatic irrigation for ecological restoration slopes at different elevations, and can also filter excess water resources for use in lower slope irrigation and power generation. This device organically integrates with the pumped-storage system, achieving water resource recycling and energy conservation.

To achieve the above technical features, the purpose of the invention is achieved as follows: an operation method of a series-parallel circulating irrigation device for ecological restoration slopes at different elevations in pumped-storage power station, wherein the series-parallel circulating irrigation device comprises a pipeline network system for irrigation water delivery; partial devices of the pumped-storage power station are connected to the pipeline network system to provide an irrigation water source; the pipeline network system is laid on ecological restoration slopes; the pipeline network system is connected to a data acquisition and processing system, and an interior of the pipeline network system is provided with a filtration device.

The pipeline network system is a plurality of PVC water pipes arranged on ecological restoration slopes, comprising a main water pipe, branch water pipes, a return water pipe, sensor-controlled bidirectional valves, sensor-controlled unidirectional valves, and a master valve; the main water pipe and the branch water pipes are connected in series, and the main water pipe is installed with the master valve; the various branch water pipes are connected in parallel and are arranged on the slope bodies of the ecological restoration slopes; the return water pipe is provided at a bottom part of the ecological restoration slopes, and the return water pipe is internally provided with the filtration device for filtering return water.

The data acquisition and processing system comprises soil moisture content sensors buried in the slope soil, a data processing device located at the slope top, and a master data processing device; a plurality of soil moisture content sensors are connected in parallel, and then connected in series to the master data processing device.

The filtration device is a semi-permeable membrane structure that only allows water to pass through.

The partial devices of the pumped-storage power station comprises an upper reservoir, a water turbine, a draft tube, and a lower reservoir; the upper reservoir is connected to the water turbine via the main water pipe, and the draft tube of the water turbine is connected to the lower reservoir.

Soil moisture content sensors are buried in the soil of ecological restoration slopes at different elevations.

For series-connected slope surfaces, an end of the branch water pipe connected to the main water pipe is provided with a bidirectional valve controlled by the soil moisture content sensor.

For parallel-connected slope surfaces, the end of the branch water pipe connected to the main water pipe is provided with a bidirectional valve controlled by the soil moisture content sensor; each branch water pipe is also internally provided with a unidirectional valve controlled by the soil moisture content sensor.

The return water pipe connects the drainage ditches at a bottom of each slope surface and is connected to the main water pipe;

an end of the main water pipe connected to an upper reservoir is provided with the master valve controlled by the master data processing device.

An operation method of a series-parallel circulating irrigation device for ecological restoration slopes at different elevations in pumped-storage power station:
when the irrigation device is in operation, it is divided into the following two situations:
S1: when the soil moisture measured by the soil moisture content sensor on a certain series-connected slope surface is less than the soil moisture content set by the system, the master data processing device controls the master valve to open, simultaneously, the data processing device on that branch controls the bidirectional valve to open at the branch water pipe and close at the main water pipe; at this time, water resources flow from the upper reservoir to the water-deficient slope surface for irrigation; simultaneously, excess water resources remaining from irrigation on that slope surface collect in the drainage ditch at the slope bottom, are filtered by the filtration device, and flow back to the main water pipe via the return water pipe for lower slope surface irrigation;
if the lower slope surface is not water-deficient, then this portion of water resources flows through the main water pipe to the water turbine for power generation; when the slope surface reaches the irrigation stop condition, i.e., the measured soil moisture content is greater than or equal to the set soil moisture, the master valve closes, and the bidirectional valve on that branch closes at the branch water pipe and opens at the main water pipe, and irrigation stops;
S2: a separate unidirectional valve is provided at each parallel slope surface branch water pipe; when one slope surface is water-deficient, the data processing device controls the corresponding unidirectional valve to open, and the remaining steps are the same as S1.

During the construction of pumped-storage power stations, widely distributed “ecological restoration slopes” with varying elevations have been formed. The invention not only enables independent and precise irrigation control for multiple slopes at the same elevation, but also utilizes the potential energy difference between high and low slopes to achieve gravity-fed irrigation, thereby enabling intelligent allocation and cyclic use of water resources from high to low elevations, effectively addressing the practical difficulty of irrigating “ecological restoration slopes.” Herein, “parallel connection” is applied to slope groups with similar elevations, allowing each slope to be independently and precisely controlled for irrigation based on its own soil moisture, achieving “on-demand allocation”; “series connection” is applied to slope groups at different elevations, establishing a cascading water flow pathway from higher to lower slopes, enabling the surplus water after irrigating higher slopes to naturally flow to lower slopes for secondary use, achieving “cascaded utilization.” The beneficial effects of the invention can be summarized as:
1. The invention is connected to a partial devices of the pumped-storage power station-a major power generation device. Utilizing pumped-storage water resources as the water source for the irrigation system can save the cost of separate water pumping.
2. Using a serial-parallel pipeline network structure and soil moisture monitoring devices, a unified irrigation system for ecological restoration slopes of pumped-storage power stations is constructed. By controlling the opening and closing of the main water pipe and various branch pipes, targeted irrigation for ecological restoration slopes at different elevations is achieved.
3. The serial-parallel cyclic irrigation device for ecological restoration slopes is fully integrated with the pumped-storage power station system, realizing automated irrigation for slope plants, solving the problem of slope maintenance requiring substantial human resources, and improving the ecological revegetation effect of slopes.
4. Excess water resources remaining from irrigation can be used for power generation, serving the pumped-storage power station system, achieving dynamic cycling and effective utilization of water resources.

### BRIEF DESCRIPTION OF ACCOMPANY DRAWINGS

The invention will be further described hereinafter with reference to the accompanying drawings and embodiments.

FIG. 1 is an application scenario diagram of the series-parallel circulating irrigation device for ecological restoration slopes at different elevations in pumped-storage power station according to the invention.

FIG. 2 is a working logic diagram of the series-parallel circulating irrigation device for ecological restoration slopes at different elevations in pumped-storage power station according to the invention.

FIG. 3 is a first arrangement logic diagram of the series-parallel circulating irrigation device for ecological restoration slopes at different elevations in pumped-storage power station according to the invention.

FIG. 4 is a second arrangement logic diagram of the series-parallel circulating irrigation device for ecological restoration slopes at different elevations in pumped-storage power station according to the invention.

FIG. 5 is a third arrangement logic diagram of the series-parallel circulating irrigation device for ecological restoration slopes at different elevations in pumped-storage power station according to the invention.

In the drawings: 1 refers to the pipeline network system; 2 refers to the data acquisition and processing system; 3 refers to the filtration device; 4 refers to the partial devices of the pumped-storage power station; 11 refers to the main water pipe; 12 refers to the branch water pipe; 13 refers to the return water pipe; 14 refers to the bidirectional valve; 15 refers to the unidirectional valve; 16 refers to the master valve; 21 refers to the soil moisture content sensor; 22 refers to the data processing device; 23 refers to the master data processing device; 41 refers to the upper reservoir; 42 refers to the water turbine; 43 refers to the draft tube; 44 refers to the lower reservoir.

### SPECIFIC EMBODIMENT OF THE INVENTION

The embodiment of the invention will be further described hereinafter with reference to the accompanying drawings.

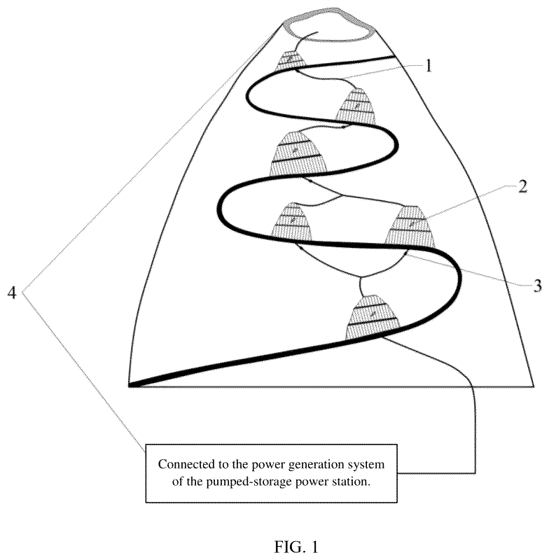

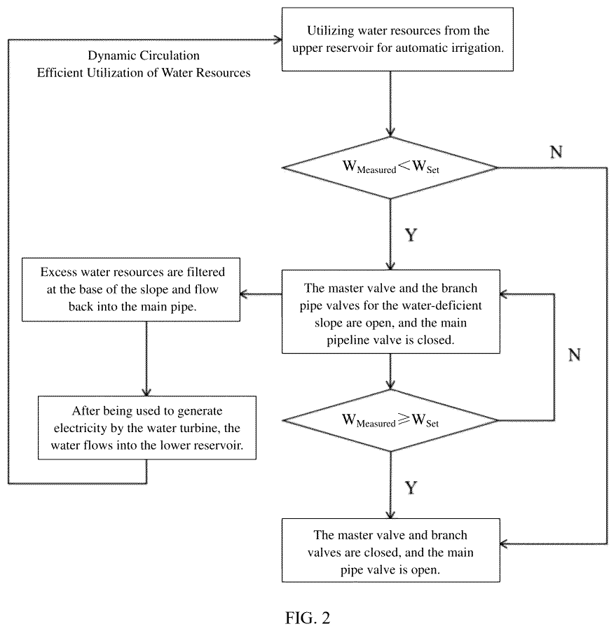

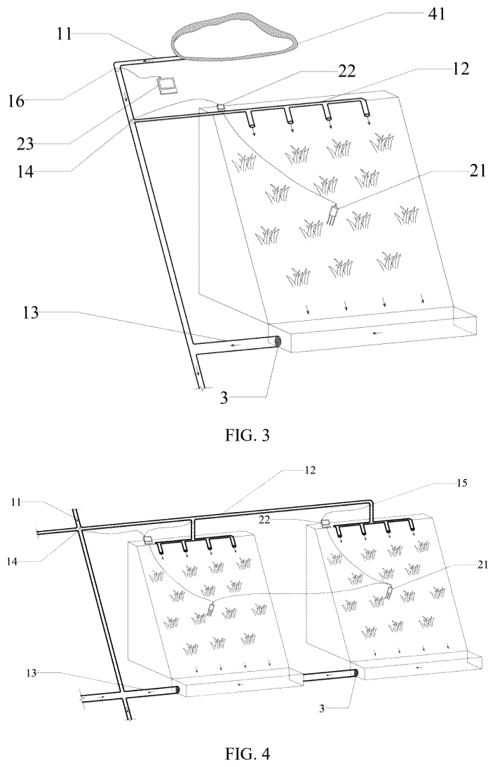

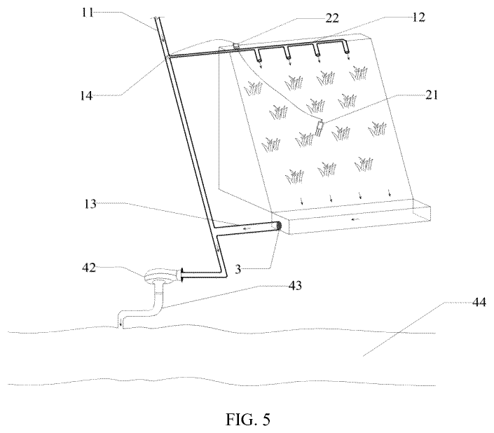

As shown in FIGS. 1-5, an operation method of a series-parallel circulating irrigation device for ecological restoration slopes at different elevations in pumped-storage power station, wherein the series-parallel circulating irrigation device for ecological restoration slopes at different elevations in pumped-storage power station comprises a pipeline network system 1 for irrigation water delivery; partial devices of the pumped-storage power station 4 are connected to the pipeline network system 1 to provide an irrigation water source; the pipeline network system 1 is laid on ecological restoration slopes; the pipeline network system 1 is connected to a data acquisition and processing system 2, and an interior of the pipeline network system 1 is provided with a filtration device 3. Through the series-parallel circulating irrigation device for ecological restoration slopes at different elevations in pumped-storage power station, the soil moisture content sensors in the data acquisition and processing system 2 send signals to the data processing device to control valve opening and closing. This device can fully utilize pumped-storage water resources, achieve targeted automatic irrigation for ecological restoration slopes at different elevations, and can also filter excess water resources for use in lower slope irrigation and power generation. This device organically integrates with the pumped-storage system, achieving water resource recycling and energy conservation.

Further, the pipeline network system 1 is a plurality of PVC water pipes arranged on ecological restoration slopes, comprising a main water pipe 11, branch water pipes 12, a return water pipe 13, sensor-controlled bidirectional valves 14, sensor-controlled unidirectional valves 15, and a master valve 16; the main water pipe 11 and the branch water pipes 12 are connected in series, and the main water pipe 11 is installed with the master valve 16; the various branch water pipes 12 are connected in parallel and are arranged on the slope bodies of the ecological restoration slopes; the return water pipe 13 is provided at a bottom part of the ecological restoration slopes, and the return water pipe 13 is internally provided with the filtration device 3 for filtering return water. Through the pipeline network system 1, water inside the main water pipe 11 can be supplied to the corresponding branch water pipes 12, thereby irrigating the ecological restoration slopes through the branch water pipes 12, achieving return water control through the return water pipe 13, and controlling the overall water supply process through the master valve 16.

Further, the data acquisition and processing system 2 comprises soil moisture content sensors 21 buried in the slope soil, a data processing device 22 located at the slope top, and a master data processing device 23; a plurality of soil moisture content sensors 21 are connected in parallel, and then connected in series to the master data processing device 23. Through the data acquisition and processing system 2, automated control of the water supply process can be achieved through feedback regulation.

Further, the filtration device 3 is a semi-permeable membrane structure that only allows water to pass through. Through the filtration device 3, return water can be filtered.

Further, the partial devices of the pumped-storage power station 4 comprise an upper reservoir 41, a water turbine 42, a draft tube 43, and a lower reservoir 44; the upper reservoir 41 is connected to the water turbine 42 via the main water pipe 11, and the draft tube 43 of the water turbine 42 is connected to the lower reservoir 44. Through partial devices of the pumped-storage power station 4, during nighttime low electricity demand periods, the pumped-storage power station pumps water resources from the lower reservoir 44 to the upper reservoir 41 for storage. The invention utilizes pumped-storage water resources as the water source for the irrigation system, saving the cost of separate water pumping. Simultaneously, excess water resources remaining from irrigation can be used for lower slope surface irrigation, or flow to the lower reservoir 44 again via the water turbine 42 for power generation, serving the pumped-storage power station system, achieving dynamic cycling and effective utilization of water resources.

Further, soil moisture content sensors 21 are buried in the soil of ecological restoration slopes at different elevations. Through the soil moisture content sensors 21, soil moisture content can be detected, thereby achieving the purpose of automatic irrigation process control.

Further, for series-connected slope surfaces, an end of the branch water pipe 12 connected to the main water pipe 11 is provided with a bidirectional valve 14 controlled by the soil moisture content sensor 21.

Further, for parallel-connected slope surfaces, the end of the branch water pipe 12 connected to the main water pipe 11 is provided with a bidirectional valve 14 controlled by the soil moisture content sensor 21; each branch water pipe 12 is also internally provided with a unidirectional valve 15 controlled by the soil moisture content sensor 21.

Further, the return water pipe 13 connects the drainage ditches at a bottom of each slope surface and is connected to the main water pipe 11. Through the return water pipe 13, irrigation water return control can be achieved.

Further, an end of the main water pipe 11 connected to an upper reservoir 41 is provided with the master valve 16 controlled by the master data processing device 23. Through the master valve 16, water supply control of the main water pipe 11 can be controlled.

### Embodiment 2

During nighttime low electricity demand periods, the pumped-storage power station pumps water resources from the lower reservoir 44 to the upper reservoir 41 for storage. The invention utilizes pumped-storage water resources as the water source for the irrigation system, saving the cost of separate water pumping. Simultaneously, excess water resources remaining from irrigation can be used for lower slope surface irrigation, or flow to the lower reservoir 44 again via the water turbine 42 for power generation, serving the pumped-storage power station system, achieving dynamic cycling and effective utilization of water resources.

### Embodiment 3

An operation method of a series-parallel circulating irrigation device for ecological restoration slopes at different elevations in pumped-storage power station:
when the irrigation device is in operation, it is divided into the following two situations:
S1: when the soil moisture measured by the soil moisture content sensor 21 on a certain series-connected slope surface is less than the soil moisture content set by the system, the master data processing device 23 controls the master valve 16 to open, simultaneously, the data processing device 22 on that branch controls the bidirectional valve 14 to open at the branch water pipe 12 and close at the main water pipe 11; at this time, water resources flow from the upper reservoir 41 to the water-deficient slope surface for irrigation; simultaneously, excess water resources remaining from irrigation on that slope surface collect in the drainage ditch at the slope bottom, are filtered by the filtration device 3, and flow back to the main water pipe 11 via the return water pipe 13 for lower slope surface irrigation;
if the lower slope surface is not water-deficient, then this portion of water resources flows through the main water pipe 11 to the water turbine 42 for power generation; when the slope surface reaches the irrigation stop condition, i.e., the measured soil moisture content is greater than or equal to the set soil moisture, the master valve 16 closes, and the bidirectional valve 14 on that branch closes at the branch water pipe 12 and opens at the main water pipe 11, and irrigation stops;
S2: a separate unidirectional valve 15 is provided at each parallel-connected slope surface branch water pipe 12; when one slope surface is water-deficient, the data processing device 22 controls the corresponding unidirectional valve 15 to open, and the remaining steps are the same as S1.

1. An operation method of series-parallel circulating irrigation device for ecological restoration slopes at different elevations in pumped-storage power station, wherein the circulating irrigation device comprises a pipeline network system for irrigation water delivery; partial devices of the pumped-storage power station are connected to the pipeline network system to provide an irrigation water source; the pipeline network system is laid on the ecological restoration slopes; the pipeline network system is connected to a data acquisition and processing system, and an interior of the pipeline network system is provided with a filtration device;
the pipeline network system is a plurality of PVC water pipes arranged on the ecological restoration slopes, comprising a main water pipe, branch water pipes, a return water pipe, sensor-controlled bidirectional valves, sensor-controlled unidirectional valves, and a master valve; the main water pipe and the branch water pipes are connected in series, and the main water pipe is installed with the master valve; the various branch water pipes are connected in parallel and are arranged on the slope bodies of the ecological restoration slopes; the return water pipe is provided at a bottom part of the ecological restoration slopes, and the return water pipe is internally provided with the filtration device for filtering return water;
the data acquisition and processing system comprises soil moisture content sensors buried in the slope soil, data processing devices located at the top of each slope, and a master data processing device located between the upper reservoir and the highest slope; a plurality of soil moisture content sensors are connected in parallel, and then connected in series to the master data processing device;
the return water pipe connects the drainage ditches at a bottom of each slope surface and is connected to the main water pipe;
an end of the main water pipe connected to an upper reservoir is provided with the master valve controlled by the master data processing device;
the partial devices of the pumped-storage power station comprise an upper reservoir, a water turbine, a draft tube, and a lower reservoir; the upper reservoir is connected to the water turbine via the main water pipe, and the draft tube of the water turbine is connected to the lower reservoir;
for series-connected slope surfaces, an end of the branch water pipe connected to the main water pipe is provided with a bidirectional valve controlled by the soil moisture content sensor;
for parallel-connected slope surfaces, the end of the branch water pipe connected to the main water pipe is provided with a bidirectional valve controlled by the soil moisture content sensor; and each branch water pipe is also internally provided with a unidirectional valve controlled by the soil moisture content sensor;
wherein the operation method includes:
when the irrigation device is in operation, it is divided into the following two situations:
S1: when the soil moisture measured by the soil moisture content sensor on a certain series-connected slope surface is less than the soil moisture content set by the system, the master data processing device controls the master valve to open, simultaneously, the data processing device on that branch controls the bidirectional valve to open at the branch water pipe and close at the main water pipe; at this time, water resources flow from the upper reservoir to the water-deficient slope surface for irrigation; simultaneously, excess water resources remaining from irrigation on that slope surface collect in the drainage ditch at the slope bottom, are filtered by the filtration device, and flow back to the main water pipe via the return water pipe for lower slope surface irrigation;
if the lower slope surface is not water-deficient, then this portion of water resources flows through the main water pipe to the water turbine for power generation; when the slope surface reaches the irrigation stop condition, i.e., the measured soil moisture content is greater than or equal to the set soil moisture, the master valve closes, and the bidirectional valve on that branch closes at the branch water pipe and opens at the main water pipe, and irrigation stops;
S2: a separate unidirectional valve is provided at each parallel-connected slope surface branch water pipe; when one slope surface is water-deficient, the data processing device controls the corresponding unidirectional valve to open, and the remaining steps are the same as S1.

2. The operation method of series-parallel circulating irrigation device for ecological restoration slopes at different elevations in pumped-storage power station of claim 1, wherein the filtration device is a semi-permeable membrane structure that only allows water to pass through.

3. The operation method of series-parallel circulating irrigation device for ecological restoration slopes at different elevations in pumped-storage power station of claim 1, wherein soil moisture content sensors are buried in the soil of the ecological restoration slopes at different elevations.
